(19) United States
(12) Patent Application Publication
(10) Pub. No.: US 2023/0108596 A1
(43) Pub. Date: Apr. 6, 2023

(54) METHODS AND SYSTEMS FOR A GAS INFUSION BEVERAGE DISTRIBUTION ASSEMBLY

(71) Applicant: HYDRODYNAMICA LLC, Wallingford, CT (US)

(72) Inventors: Michel Seth BOISSY, Wallingford, CT (US); Eric T. STEIGELMAN, San Diego, CA (US)

(21) Appl. No.: 17/802,995

(22) PCT Filed: Feb. 26, 2021
(86) PCT No.: PCT/US21/19951

§ 371 Date: Aug. 29, 2022

Related U.S. Application Data
(60) Provisional application No. 62/983,282, filed on Feb. 28, 2020.
(60) Provisional application No. 63/028,799, filed on May 22, 2020.

(51) Int. Cl. B01F 23/236; B67D 1/08; B67D 1/00; A23L 2/54; C12G 3/04; B01F 23/237; B01F 25/312; B01F 25/431; B01F 23/70; B01F 35/92; A23F 5/24

(52) U.S. Cl. CPC B01F 23/2362; B67D 1/0862; B67D 1/0021; B67D 1/0048; A23L 2/54; C12G 3/04; B01F 23/237621; B01F 25/3121; B01F 25/43161; B01F 23/702; B01F 35/92; A23F 5/243; B67D 2001/0481

(57) ABSTRACT

A system and method for providing a consumable liquid infused with gas from a liquid processor. The liquid processor may comprise a gas input port configured to receive the compressed gas. The liquid processor may further comprise a liquid input port configured to receive a consumable liquid. The liquid processor may further comprise a venturi injector configured to combine the compressed gas with the consumable liquid. The liquid processor may further comprise a static inline mixer including a plurality of mixing elements and configured to mix the combined consumable liquid with the compressed gas to form the consumable liquid infused with a compressed gas. The liquid processor may further comprise an output port configured to provide the consumable liquid infused with a compressed gas.

### CROSS-REFERENCE TO RELATED APPLICATIONS

The present document claims priority to U.S. Provisional Patent Application No. 62/983,282 filed on Feb. 28, 2020, and to U.S. Provisional Patent Application No. 63/028,799 filed on May 22, 2020, and the contents of each are incorporated by reference herein in their entireties.

### TECHNICAL FIELD

Aspects of the present disclosure are directed to systems and methods for mixing and distribution of beverages infused with a gas.

### BACKGROUND

The infusion of nitrogen gas into beverages have become increasingly popular by adults and food fanatics alike because of the mouth-feel smoothness and complex flavors created when being infused by a compressed gas such as nitrogen.

To date, the only method to combine a consumable liquid, such as coffee, and a gas, such as nitrogen, together is to configure a beverage tap with a restrictor plate to squeeze the liquid through tiny holes after combining the gas. This is because nitrogen does dissolve easily with water. Once infused, the consumable liquid has a particularly smooth and frothy head. Although this method works well when infusing coffee with nitrogen, a vast amount of the consumable liquid is lost/wasted in the frothy head when pouring the via the tap. This waste is not ideal for businesses that rely profits.

In view of the foregoing, due to the increased demand for these popular gas infused liquids, new methods and systems of mixing and dispensing these liquids are required in order to try and quench the consumers' never ending thirst for these products. Further advantages and novel features will become apparent from the disclosure provided below.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

In one aspect, the disclosure provides a system for infusing and dispensing a consumable liquid with a compressed gas via a plurality of inline mixers.

In another aspect, the disclosure provides a method for infusing and dispensing a consumable liquid with a compressed gas via plurality of inline mixers.

Additional advantages and novel features of the systems and methods of the present disclosure will be set forth in part in the description that follows, and in part will become more apparent to those skilled in the art upon examination of the following or upon learning by practice of the disclosure.

### BRIEF DESCRIPTION OF THE DRAWINGS

The novel features believed to be characteristic of the disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advances thereof, will be best understood by reference to the following detailed description of illustrative aspects of the disclosure when read in conjunction with the accompanying drawings, wherein:

FIG. 1 is a front view of a system for infusing and dispensing of consumable liquids output from a distribution device in accordance with aspects of the present disclosure;

FIG. 2 is an internal view of a system for infusing and dispensing the consumable liquids in accordance with aspects of the present disclosure;

FIG. 3 is an exploded view of a pump/mixing unit in accordance with aspects of the present disclosure;

FIG. 4 is a detailed view of a liquid processor in accordance with aspects of the present disclosure;

FIG. 5 is a detailed view of a mixing chamber in accordance with aspects of the present disclosure;

FIGS. 6-8 illustrate an example arrangement of various components of the system for infusing and dispensing of consumable liquids in accordance with aspects of the present disclosure; and

FIG. 9 is an internal view of a system for infusing and dispensing a consumable liquid in accordance with aspects of the present disclosure.

The detailed description explains embodiments of the present disclosure, together with advantages and features, by way of example with reference to the drawings.

### DETAILED DESCRIPTION OF THE INVENTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

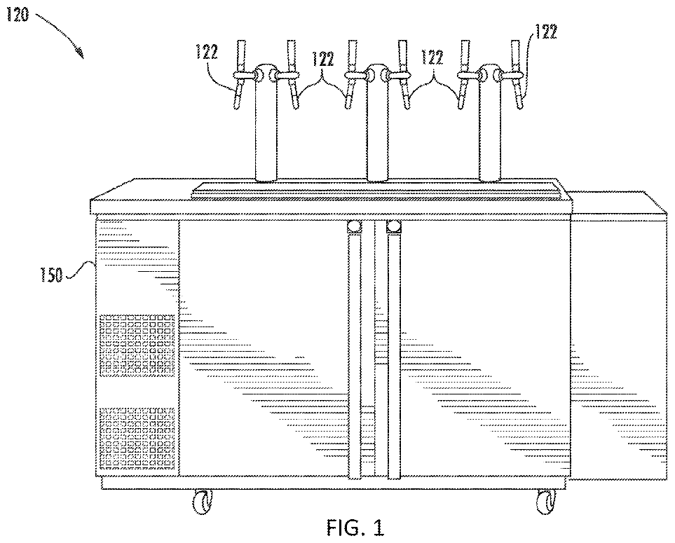

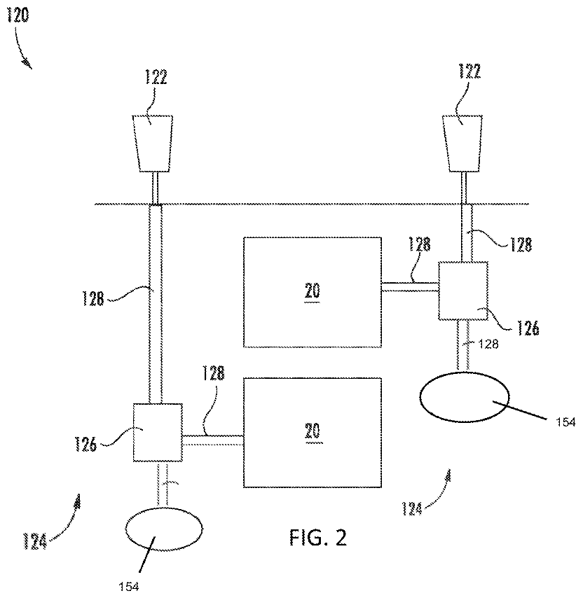

Referring to FIGS. 1-9, illustrate examples of a beverage assembly 120 for serving one or more consumable liquids infused with a gas are shown. In one aspect of the disclosure, a single liquid is input to the system and infused with a gas. In another aspect of the disclosure a liquid pre-infused with a gas in input to the system and infused with a second liquid. The beverage assembly 120 includes one or more distribution devices 122, such as taps or fountains for example, operable to provide a consumable liquid therefrom, such as a beverage including a cold-pressed, fresh juice, coffee, beer, etc. In the illustrated, non-limiting disclosure of FIG. 1, the assembly 120 may include six distribution devices 122; however, an assembly 120 having any number of distribution devices 122 is contemplated herein. The assembly 120 additionally includes a system 124, illustrated in FIG. 2, for delivering the consumable liquid to a corresponding distribution device 122. It should be understood that in the disclosure where the assembly 120 includes a plurality of distribution devices 122, the assembly 120 includes a plurality of systems 124, each of which is configured to provide a distinct consumable beverage to one of the plurality of distribution devices 122.

With reference to FIG. 2, each system 124 may include a container assembly 20 having an internal cavity, not shown, containing a plurality of servings of a consumable liquid. Due to the nature of the contents within the internal cavity, not shown, the container assembly 20 is located within a refrigerated area. In one aspect of the disclosure, the consumable liquid located in the container assembly 20 is coffee. In another aspect of the disclosure, the consumable liquid located in the container may be a carbonated liquid. However, it should be understood that the liquid described herein is intended as an example only, and a container assembly 20 containing another consumable liquid, such as the beer, is also within the scope of the disclosure.

In another aspect of the disclosure where each distribution device 122 is configured to output a single consumable liquid, as shown in FIG. 2, the each system 124 includes a pump/mixer assembly 126 operably coupled to each respective container assembly 20, distribution device 122 and a canister 154 containing compressed gas, described below, via one or more conduits 128. The canister 154, as described below, may also comprises a liquid, for example a syrup or an alcoholic liquid. The a pump/mixer assembly 126, described below, may interoperate with a compressed gas, for example air, nitrogen or carbon dioxide stored in the canister 154. In another aspect of the disclosure, the a pump/mixer assembly 126, described below, may interoperate with a liquid, for example vodka, rum, tequila or syrup stored in the canister 154. Actuation of the distribution device 122, such as by rotation thereof about an axis, initiates operation the pump/mixer assembly 126. During operation, the pump/mixer assembly 126 draws consumable liquid from the container assembly 20, compressed gas or liquid contained in the canister 154, combines and supplies it to the distribution device 122.

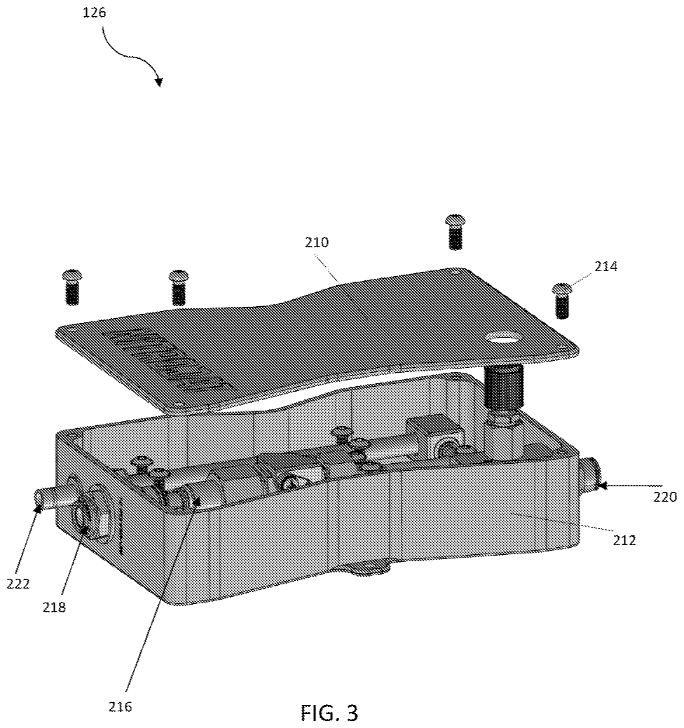

Referring to FIG. 3, illustrates an exploded view of the pump/mixer assembly 126, as referenced in FIGS. 1-9. The pump/mixer assembly 126 may include a housing 212, a housing cover 210, and securing devices 214. The securing devices 214 may be bolts, screws, etc., to secure the housing cover 210 to the housing 212. Inside the housing 212, the pump/mixer assembly 126 may include a liquid processor 216, described below. The liquid processor 216 may include an beverage input port 218, which may receive the liquid from the container assembly 20. As described below in accordance with another aspect of the disclosure, the beverage input port 218 may also receive a liquid already mixed with a gas. Further, the liquid processor 216 may also include an gas input port 220, which may receive the gas from the canister 154. As described below in accordance with another aspect of the disclosure, the gas input port 220 may also receive a liquid, for example, alcohol, soda syrup, and the like. Further, the liquid processor 216 may also include an beverage output port 222, which may transmit the infused consumable beverage to the distribution device 122. In one aspect of the disclosure, the ports 218, 222 and 220 may be connected to their respective devices via conduits 128, as described above.

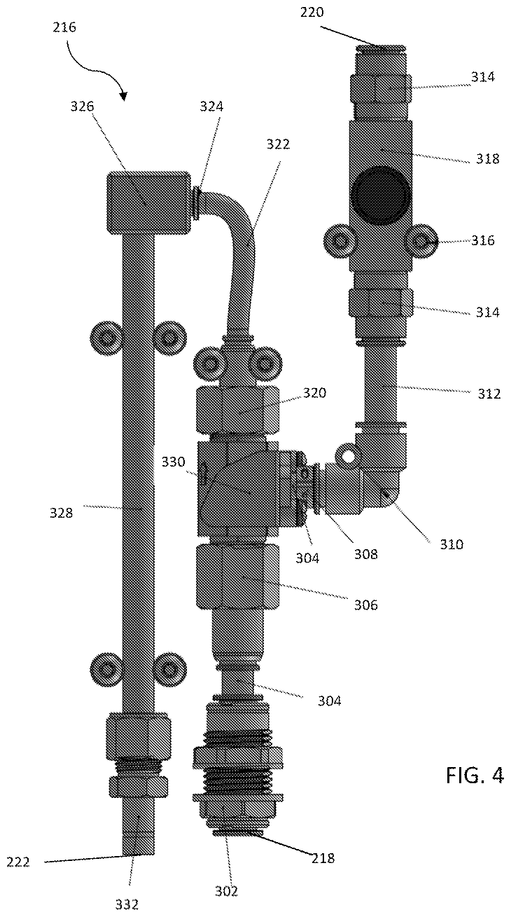

Referring to FIG. 4, illustrates a detailed view of the liquid processor 216 as referenced in FIG. 3, described above. In one aspect of the disclosure the liquid processor 216 may include, the beverage input port 218, an input bulkhead fitting 302, a first tubing 304, a first fitting 306, a clamp 308, an elbow fitting 310, a second tubing 312, a second fitting 314, an attachment device 316, a value 318, the gas input port 220, a third fitting 320, a third tubing 322, a cartridge 324, a 90 degree fitting 326, a static inline mixer 328, a venturi injector 330, a fourth tubing 332 and the beverage output port 222. In one aspect of the disclosure, the first, second, third and fourth tubing, 304, 312, 322 332, respectively, may include antibacterial tubing and/or may also not include polyvinyl chloride (PVC).

In another aspect of the disclosure, the liquid processor may receive consumable liquid via the beverage input port 218 and the gas, for example nitrogen, via the gas input port 220. In another aspect of the disclosure, the liquid processor may receive consumable liquid infused with a gas via the beverage input port 218, and an additional liquid, for example alcohol or syrup, via the gas input port 220. The gas or additional liquid and the consumable liquid may pass through the liquid processor and first be mixed by the venturi injector 330. The venturi injector 330 mixes the liquid and the gas or additional liquid into a stream of infused consumable liquid. The venturi injector 330 works on the principle of differential pressure. The consumable liquid enters the venturi injector at a higher pressure than it exits. The difference in the entry and exit pressures creates a vacuum at the suction port on the side of the venturi injector which is connected to the gas or additional liquid. The bigger the difference, the greater the vacuum and therefore the efficiency of the mixing of the consumable liquid and the gas or additional liquid. In one aspect of the disclosure, the venturi injector 330 may combine the liquid from the beverage input port 218 and the additional liquid from the gas input port 220 at a ratio of 1:1 or higher. In another aspect of the disclosure the pressure for which the venturi injector 330 operates at would be from 60 PSI to 120 PSI.

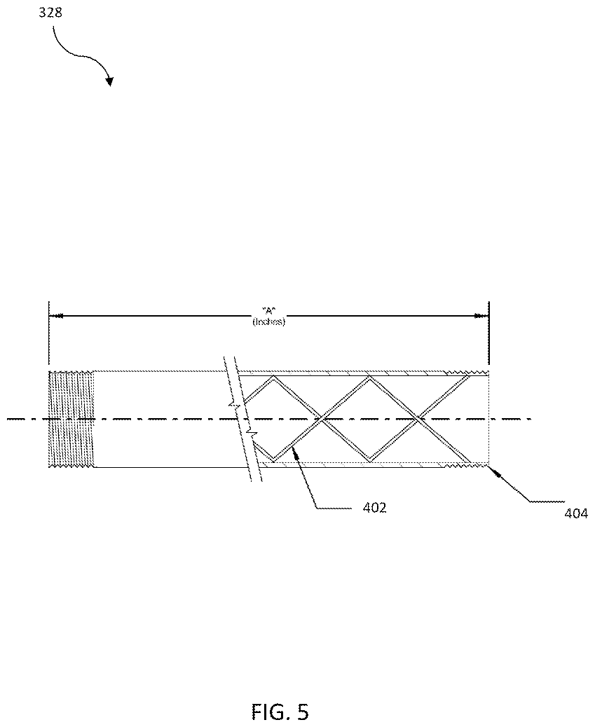

In another aspect of the disclosure, the venturi injected consumable liquid infused with the gas is passed on to the static inline mixer 328. The static inline mixer 328 is described in detail below in relation to FIG. 5. Thus, after the venturi injected consumable liquid infused with the gas is further mixed by the static inline mixer 328, it is then passed on to the beverage output port 222. As described above, the beverage output port 222 may be connected to distribution device 122.

Referring to FIG. 5, illustrates a detailed view of the static inline mixer 328 as referenced in FIG. 3, described above. The static inline mixer, also known as a motionless mixer, may include a plurality individual mixing elements 402 stacked in series. Each mixing element may be oriented 90 degrees relative to the adjacent mixing element 402 to create homogeneous mixing in both the horizontal and vertical directions. The static mixing elements 402 may divide and recombine the venturi injected consumable liquid infused with the gas so that the stream exiting the static inline mixer 328 is homogeneous with regard to concentration, temperature and velocity which are equalized throughout the entire pipe cross-section.

The static inline mixer 328 may be variable in length, as indicated by “A” inches in FIG. 5. Table 1 provided below, defines the number of mixing elements 402 based upon the length of the inline static mixer in inches, “A”. Further, Table 1 additionally provides for the number of mixing elements 402 based upon the overall pipe size.

TABLE 1

| Nominal | “A” | | | | | | | |
|---|---|---|---|---|---|---|---|---|
| Pipe | Number of Elements | | | | | | “B” | “C” |
| Size | 2 | 3 | 4 | 5 | 6 | 12 | I.D. | O.D. |
| 1/4″ | 1.5 | 1.5 | 2 | 2.5 | 3 | 6 | 0.364 | 0.540 |
| 3/8″ | 2 | 2 | 3 | 3.5 | 4 | 8 | 0.493 | 0.675 |
| 1/2″ | 2 | 3 | 3.5 | 4 | 5 | 10 | 0.622 | 0.840 |
| 3/4″ | 2.5 | 3.5 | 5 | 6 | 7 | 13 | 0.824 | 1.050 |
| 1″ | 3 | 4 | 6 | 7 | 9 | 17 | 1.049 | 1.315 |
| 1-1/4″ | 4 | 6 | 8 | 10 | 12 | 22 | 1.380 | 1.660 |
| 1-1/2″ | 5 | 7 | 9 | 11 | 13 | 26 | 1.610 | 1.900 |
| 2″ | 6 | 8 | 11 | 14 | 17 | 33 | 2.067 | 2.375 |
| 2-1/2″ | 10 | 13 | 15 | 18 | 20 | 39 | 2.469 | 2.875 |
| 3″ | 11 | 14 | 18 | 23 | 27 | 49 | 3.068 | 3.500 |
| 4″ | 14 | 19 | 24 | 29 | 36 | 65 | 4.026 | 4.500 |

As described above, the static inline mixer 328 may be connected to the beverage output port 222 via a connection of the fourth tubing 332 with threads 404, By further mixing the venturi injected consumable liquid infused with the gas through the static inline mixer, the final output product may be taste and feel smoother and with a higher quality mouth-feel.

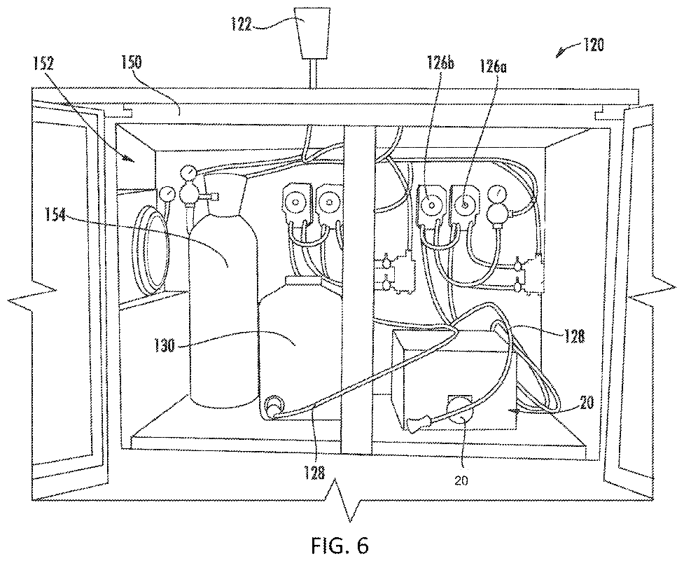

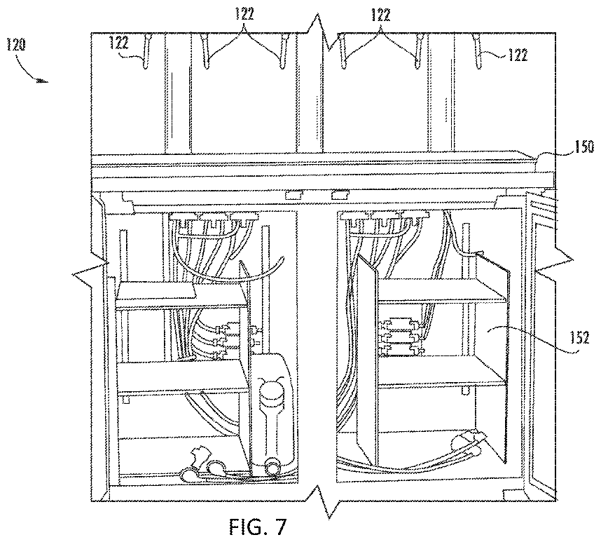

Referring to FIG. 6, illustrates a beverage assembly 120 having a “local” configuration. Note, a “long” configuration is described below. When the beverage assembly 120 has a “local” configuration, the assembly includes a self-contained unit 150, as shown in FIG. 6. In one aspect of the disclosure, the unit 150 may include at least one refrigerated cavity 152 and the distribution device 122 may be mounted directly or indirectly to an exterior of the unit 150. Each system 124 of the assembly 120, may include the container assembly 20 and pump/mixer assembly 126, as described above, within the interior of the refrigerated cavity 152. The source of the compressed gas, as described above, referenced as canister 154, may be associated with the one or more pump/mixer assemblies 126a and 126b of each system 124, and may also be located within the refrigerated cavity 152, as shown in FIG. 6, or alternatively, may be positioned elsewhere, such as within a non-refrigerated cavity (not shown) of the unit 150, or separate from the unit 150, as shown in FIG. 7. It should be understood that the beverage assembly 120 may be formed via modification of any residential or commercial tap system, such as a Kegerator® or fountain tap system for example.

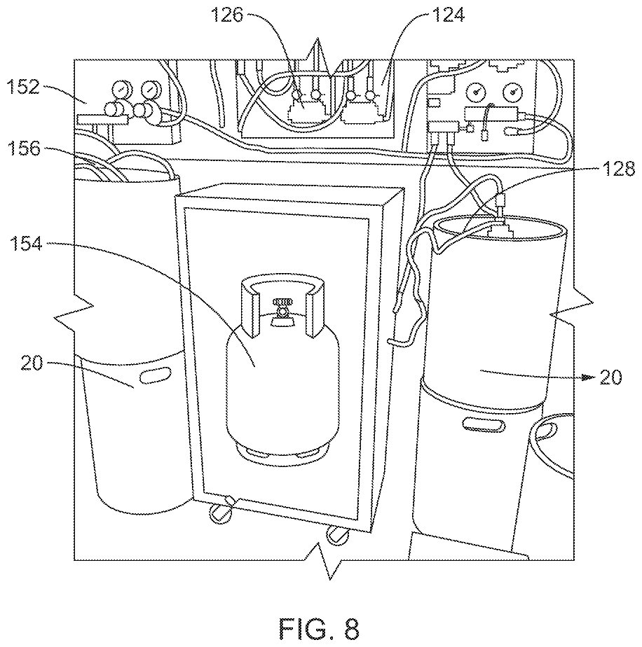

Alternatively, when the beverage assembly 120 has a “long run” configuration, as shown in FIG. 8, at least a portion of the system 124 is positioned within a refrigerated cavity 152, such as within a walk-in cooler in the storage area of a restaurant for example, arranged at a different location than the distribution device 122. As a result, one or more conduits 128 of the system 124 may extend through walls, cabinets, or other components illustrated schematically at 156. In addition, the canister 154 comprising the gas, may be associated with the one or more pump/mixer assemblies 126 and may be located within the refrigerated cavity 152, adjacent the container assembly 20, or at any suitable position there between.

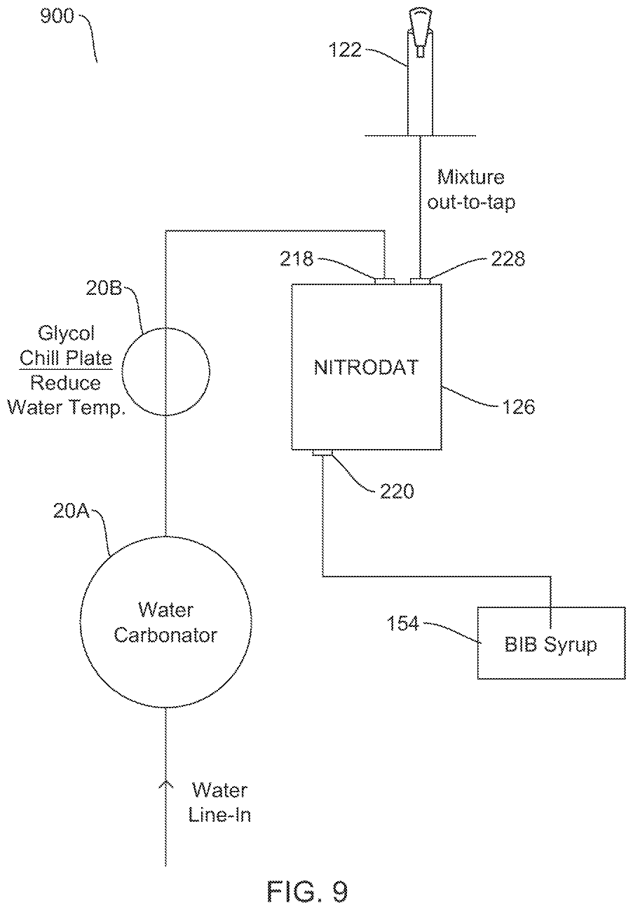

With reference to FIG. 9, the system 900 may include a container assembly, as described in reference to element 20 in FIG. 3 above, which is made of a liquid/water carbonator 20A and a chill plate 20B. The liquid/water carbonator may be any form of carbonator that combines CO₂ gas and a liquid. The chill plate 20B may be, for example, a glycol chiller plate. the container assembly 20A and 20B may be located within a refrigerated area or outside the refrigerated area. In one aspect of the disclosure, the consumable liquid located in the container assembly 20 may be water. However, it should be understood that the liquid described herein is intended as an example only, and a container assembly 20 containing another consumable liquid, such as the beer, is also within the scope of the disclosure. A water line may be supplied to the liquid/water carbonator 20A. The water contained within the waterline may be carbonated by the water carbonator 20A. The carbonated water output from the water carbonator 20A may be input to the chill plate 20B.

In another aspect of the disclosure where the distribution device 122 is configured to output a single consumable liquid, as shown in FIG. 9, the system 900 includes a pump/mixer assembly 126 operably coupled to a container assembly 20A and 20B, distribution device 122 and a canister 154 containing a liquid, for example a syrup or an alcoholic liquid. The a pump/mixer assembly 126, described above, may interoperate with a liquid, for example vodka, rum, tequila or syrup stored in the canister 154. Actuation of the distribution device 122, such as by rotation thereof about an axis, initiates operation the pump/mixer assembly 126. During operation, the pump/mixer assembly 126 draws consumable liquid from the container assembly 20A and 20B, liquid contained in the canister 154, combines and supplies it to the distribution device 122. In one aspect of the disclosure, the input port 220, described above, may further comprise a meter to count/record the flow of the additional liquid from the canister 154. In another aspect of the disclosure, the meter may be configured to adjust the amount and/or flow of the liquid with the canister 154 that drawn via the venturi injector 330 process, described above.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of the processes/flowcharts disclosed is an illustration of example approaches. Based upon design preferences, it is understood that the specific order or hierarchy in the processes/flowcharts may be rearranged. Further, some features/steps may be combined or omitted. The accompanying method claims present elements of the various features/steps in a sample order, and are not meant to be limited to the specific order or hierarchy presented.

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B. or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

What is claimed is:

1. A beverage distribution assembly comprising:
a gas input port configured to receive a compressed gas;
a liquid input port configured to receive a consumable liquid;
a venturi injector configured to combine the compressed gas with the consumable liquid;
a static inline mixer including a plurality of mixing elements and configured to mix the combined consumable liquid with the compressed gas to form a consumable liquid infused with a compressed gas; and
an output port configured to provide the consumable liquid infused with a compressed gas.

2. The beverage distribution assembly of claim 1, wherein the plurality of mixing elements divide and recombine the combined consumable liquid with the compressed gas so that the consumable liquid infused with a compressed gas exiting the static inline mixer is homogeneous with regard to concentration, temperature and velocity.

3. The beverage distribution assembly of claim 1, wherein a number of the plurality of mixing elements is from 1.5 to 65, a length of the static inline mixer from is from 2 to 12 inches, and a diameter of the static inline mixer is from a ¼ to 4 inches.

4. The beverage distribution assembly of claim 1, wherein the plurality of mixing elements intersect at an angle of 90 degrees.

5. The beverage distribution assembly of claim 1, wherein the compressed gas is a carbonated liquid, and the consumable liquid is a syrup or an alcoholic liquid.

6. The beverage distribution assembly of claim 5, further comprising a chill plate for chilling the carbonated liquid prior to being received by the gas input port.

7. The beverage distribution assembly of claim 1, wherein the compressed gas is nitrogen, and the consumable liquid is a coffee.

8. The beverage distribution assembly of claim 1, further comprising an adjustment knob configured to adjust an amount of consumable liquid provided to the venturi injector.

9. A method for generating a consumable liquid infused with a compressed gas, the method comprising:
combining via a venturi injector a compressed gas with a consumable liquid;
mixing via a static inline mixer the combined consumable liquid with the compressed gas to form the consumable liquid infused with a compressed gas; and
outputting the consumable liquid infused with a compressed gas,
wherein the static inline mixer includes a plurality of mixing elements.

10. The method of claim 9, wherein the plurality of mixing elements divide and recombine the combined consumable liquid with the compressed gas so that the consumable liquid infused with a compressed gas exiting the static inline mixer is homogeneous with regard to concentration, temperature and velocity.

11. The method of claim 9, wherein a number of the plurality of mixing elements is from 1.5 to 65, a length of the static inline mixer from is from 2 to 12 inches, and a diameter of the static inline mixer is from ¼ to 4 inches.

12. The method of claim 9, wherein the plurality of mixing elements intersect at an angle of 90 degrees.

13. The method of claim 9, wherein the compressed gas is a carbonated liquid, and the consumable liquid is a syrup or an alcoholic liquid.

14. The method of claim 13, further comprising passing the carbonated liquid through a chill plate prior to being combined via the venturi injector.

15. The method of claim 9, wherein the compressed gas is nitrogen, and the consumable liquid is a coffee.
